(19) United States
(12) Patent Application Publication
(10) Pub. No.: US 2026/0057375 A1
(43) Pub. Date: Feb. 26, 2026

(54) SYSTEM AND METHOD FOR AGGREGATING DIGITAL RESOURCES VIA A LARGE LANGUAGE MODEL (LLM) GRID WITH SEALED INTERFACES FOR AUTOMATIC SERVICE DELIVERY

(71) Applicant: BANK OF AMERICA CORPORATION, Charlotte, NC (US)

(72) Inventors: Debraj Goswami, Hyderabad (IN); Chinmay S. Barhale, Hyderabad (IN); Deepak S. Dhokane, Palghar (IN); Srikanth Janardhan Rao, Hyderabad (IN)

(73) Assignee: BANK OF AMERICA CORPORATION, Charlotte, NC (US)

(21) Appl. No.: 18/811,478

(22) Filed: Aug. 21, 2024

(51) Int. Cl. G06Q 20/36

(52) U.S. Cl. CPC G06Q 20/3678

(57) ABSTRACT

Systems, computer program products, and methods are described herein aggregating digital resources via a large language model (LLM) grid with sealed interfaces for automatic service delivery. The present disclosure is configured to generate a parent non-fungible cryptographic token (NFT) for a primary exchange between an initiator and a receiver; generate a set of child NFTs from the parent NFT for a set of sub receivers within the primary exchange, where a child NFT is linked to a sub receiver; create a set of automatic service delivery agreements for each child NFT generated using a large language model (LLM) grid; encrypt the set of automatic service delivery agreements generated by the LLM grid; aggregate the set of automatic service delivery agreements into a centralized service delivery agreement; and transmit the centralized service delivery agreement to the initiator and the receiver.

### TECHNOLOGICAL FIELD

Example embodiments of the present disclosure relate to systems and methods for aggregating digital resources via a large language model (LLM) grid with sealed interfaces for automatic service delivery.

### BACKGROUND

In complicated resource exchanges, verifying, tracking, and executing multiple exchanges within a primary exchange may result in errors, inefficiencies, and overcomplications.

Applicant has identified a number of deficiencies and problems associated with aggregating digital resources via a large language model (LLM) grid with sealed interfaces for automatic service delivery. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for aggregating digital resources via a large language model (LLM) grid with sealed interfaces for automatic service delivery. In one aspect, a system for aggregating digital resources via LLM grid with sealed interfaces for automatic service delivery is presented. The system comprising a processing device, at least one non-transitory storage device, and at least one processing device coupled to the at least one non-transitory storage device wherein the at least one processing device is configured to: generate a parent non-fungible cryptographic token (NFT) for a primary exchange between an initiator and a receiver; generate a set of child NFTs from the parent NFT for a set of sub receivers within the primary exchange, wherein a child NFT within the set of child NFTs is linked to a sub receiver within the set of sub receivers; create a set of automatic service delivery agreements for each child NFT generated using a large language model (LLM) grid; encrypt the set of automatic service delivery agreements generated by the LLM grid; aggregate the set of automatic service delivery agreements into a centralized service delivery agreement; and transmit the centralized service delivery agreement to the initiator and the receiver.

In some embodiments, the processing device may further be configured to generate a child NFT for an offline sub receiver and create corresponding automatic service delivery agreements associated with the offline sub receiver and child NFT.

In some embodiments, the processing device may further be configured to receive evaluations associated with the set of automatic service delivery agreements by the initiator.

In some embodiments, the processing device may further be configured to recommend sub receivers from the set of sub receivers via a machine learning model (MLM) based on evaluations from previously encountered initiators.

In some embodiments, creation of automatic service delivery agreements by the LLM grid is at least partially altered based on a geographic location and a set of regulations associated with the geographic location.

In some embodiments, the set of automatic service delivery agreements are encrypted using homomorphic encryption.

In some embodiments, the set of automatic service delivery agreements are encrypted using dual encryption.

In another aspect, a computer program product for aggregating digital resources via a LLM grid with sealed interfaces for automatic service delivery is presented. The computer program product comprising at least one non-transitory computer-readable medium having computer-readable program code portions embodied therein, the computer-readable program code portions which when executed by a processing device are configured to cause the processor to perform the following operations: generate a parent non-fungible cryptographic token (NFT) for a primary exchange between an initiator and a receiver; generate a set of child NFTs from the parent NFT for a set of sub receivers within the primary exchange, wherein a child NFT within the set of child NFTs is linked to a sub receiver within the set of sub receivers; create a set of automatic service delivery agreements for each child NFT generated using a large language model (LLM) grid; encrypt the set of automatic service delivery agreements generated by the LLM grid; aggregate the set of automatic service delivery agreements into a centralized service delivery agreement; and transmit the centralized service delivery agreement to the initiator and the receiver.

In some embodiments, the processing device may further be configured to cause the processor to generate an offline child NFT for a service delivery agreement created by an offline sub receiver.

In some embodiments, the processing device may further be configured to cause the processor to receive evaluations associated with the set of automatic service delivery agreements by the initiator.

In some embodiments, the processing device may further be configured to cause the processor to recommend sub receivers from the set of sub receivers via a machine learning model (MLM) based on evaluations from previously encountered initiators.

In some embodiments, creation of automatic service delivery agreements by the LLM grid is at least partially altered based on a geographic location and a set of regulations associated with the geographic location.

In some embodiments, the set of automatic service delivery agreements are encrypted using homomorphic encryption.

In some embodiments, the set of automatic service delivery agreements are encrypted using dual encryption.

In another aspect, a computer-implemented method for aggregating digital resources via LLM grid with sealed interfaces for automatic service delivery is presented. The computer-implemented method may include: generating a parent non-fungible cryptographic token (NFT) for a primary exchange between an initiator and a receiver; generating a set of child NFTs from the parent NFT for a set of sub receivers within the primary exchange, wherein a child NFT within the set of child NFTs is linked to a sub receiver within the set of sub receivers; creating a set of automatic service delivery agreements for each child NFT generated using a large language model (LLM) grid; encrypting the set of automatic service delivery agreements generated by the LLM grid; aggregating the set of automatic service delivery agreements into a centralized service delivery agreement; and transmitting the centralized service delivery agreement to the initiator and the receiver.

In some embodiments, the computer-implemented method further comprises generating an offline child NFT for a service delivery agreement created by an offline sub receiver.

In some embodiments, the computer-implemented method further comprises receiving evaluations associated with the set of automatic service delivery agreements by the initiator.

In some embodiments, the computer-implemented method further comprises recommending sub receivers from the set of sub receivers via a machine learning model (MLM) based on evaluations from previously encountered initiators.

In some embodiments, creating automatic service delivery agreements by the LLM grid is at least partially altered based on a geographic location and a set of regulations associated with the geographic location.

In some embodiments, the set of automatic service delivery agreements are encrypted using homomorphic encryption.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for aggregating digital resources via a large language model (LLM) grid with sealed interfaces for automatic service delivery, in accordance with an embodiment of the disclosure;

FIG. 2A illustrates an exemplary process for creating an NFT, in accordance with an embodiment of the disclosure;

FIG. 2B illustrates an exemplary NFT as a multilayered documentation of a resource, in accordance with an embodiment of the disclosure;

FIG. 3 illustrates an exemplary machine learning (ML) subsystem architecture, in accordance with an embodiment of the disclosure;

FIG. 4A illustrates an exemplary DLT architecture, in accordance with an embodiment of the disclosure;

FIG. 4B illustrates an exemplary transaction object within the DLT architecture, in accordance with an embodiment of the disclosure; and

FIG. 5 illustrates a process flow for aggregating digital resources via a large language model (LLM) grid with sealed interfaces for automatic service delivery, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

Executing complicated resource transfers within a system may include partners, sub receivers, and advanced resource exchanges. Non-fungible cryptographic tokens (NFTs) and machine learning may guarantee, authenticate, secure, and organize complicated resource transfers between parties and sub parties within the exchange/transfer.

Further executing resource transfers may create uncertainty and uneven resources to execute the transfer. Authenticating and validating sub receivers within the resource transfers and exchanges may be difficult or cumbersome. Additionally, organizing and tracking each resource exchange may face further difficulties as the number of sub receivers and exchanges within the primary exchange increases. Each exchange within the primary exchange may further need to be secured, negotiated, and have a service delivery agreement drafted at each point of the resource exchange process.

In complex resource exchanges (e.g., purchasing property, starting a business, buying an airplane), there are multiple smaller sub exchanges broken up between multiple sub receivers and the initiator of the primary exchange. Each sub receiver may have different mandates, regulations, and sub receivers of their own, further complicating the transaction. Generating a parent NFT between a first party and a second party for a resource exchange, with multiple child NFTs being generated for each sub receiver may authenticate and guarantee each exchange. For instance, if buying property, the parent NFT would issue multiple child NFTs to multiple sub receivers (e.g., one for real estate, one for inspectors, etc.). Each child NFT would have an accompanying smart contract drafted using a grid of large language models (multiple LLMs, each trained specifically on generating a contract for each sub vendor). The parent NFT, child NFTS, and the accompanying smart contracts may then be combined into a final smart contract between the first party and the institution.

Accordingly, the present disclosure describes generating a parent NFT for a primary exchange (e.g., a complicated multi-step purchase, purchasing a house, starting a business, purchasing a plane, etc.) between an initiator and a receiver. A set of child NFTs may then be generated for a set of sub receivers within the primary exchange, where an individual child NFT within the set of child NFTs is linked to a sub receiver within the set of sub receivers. In other words, sub receivers may be sub exchanges associated with the primary exchange (e.g., a primary exchange of purchasing a house may have a sub exchange between the initiator and an electrical contractor to purchase the house). A set of automatic service delivery agreements (e.g., an agreement, contract, or set of guidelines dictating the resource exchange between the initiator and receiver and/or the initiator and the set of sub receivers) may then be created using a large language model (LLM) grid. The set of automatic service delivery agreements may then be encrypted and aggregated into a centralized service delivery agreement (e.g., combining the sub exchanges within the primary exchange into a single service delivery agreement). The centralized service delivery agreement may then be transmitted to the initiator and receiver.

What is more, the present disclosure provides a technical solution to a technical problem. As described herein, the technical problem includes aggregating digital resources via a large language model (LLM) grid with sealed interfaces for automatic service delivery. The technical solution presented herein allows for aggregating digital resources via a LLM grid with sealed interfaces for automatic service delivery. In particular, aggregating digital resources via a LLM grid with sealed interfaces for automatic service delivery is an improvement over existing solutions to managing and executing complex resource exchanges, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

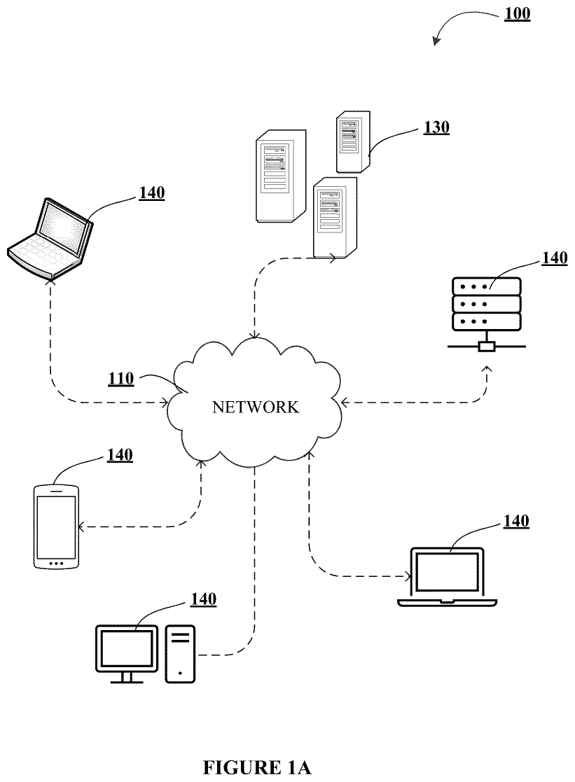

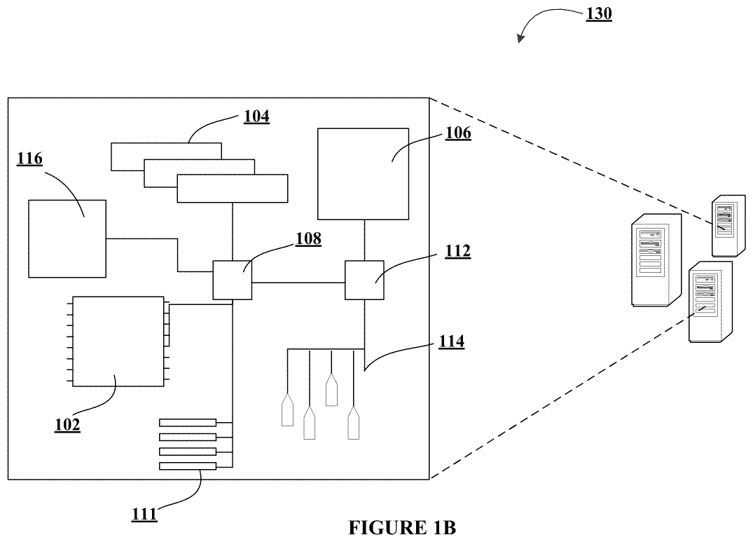

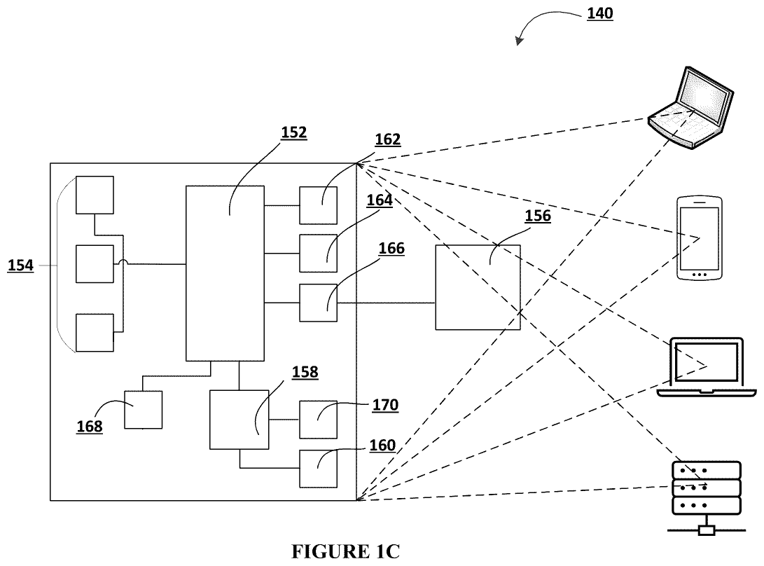

FIGS. 1A-1C illustrate technical components of an exemplary distributed computing environment for aggregating digital resources via a large language model (LLM) grid with sealed interfaces for automatic service delivery 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

An NFT is a cryptographic record (referred to as “tokens”) linked to a resource. An NFT is typically stored on a distributed ledger that certifies ownership and authenticity of the resource, and exchangeable in a peer-to-peer network.

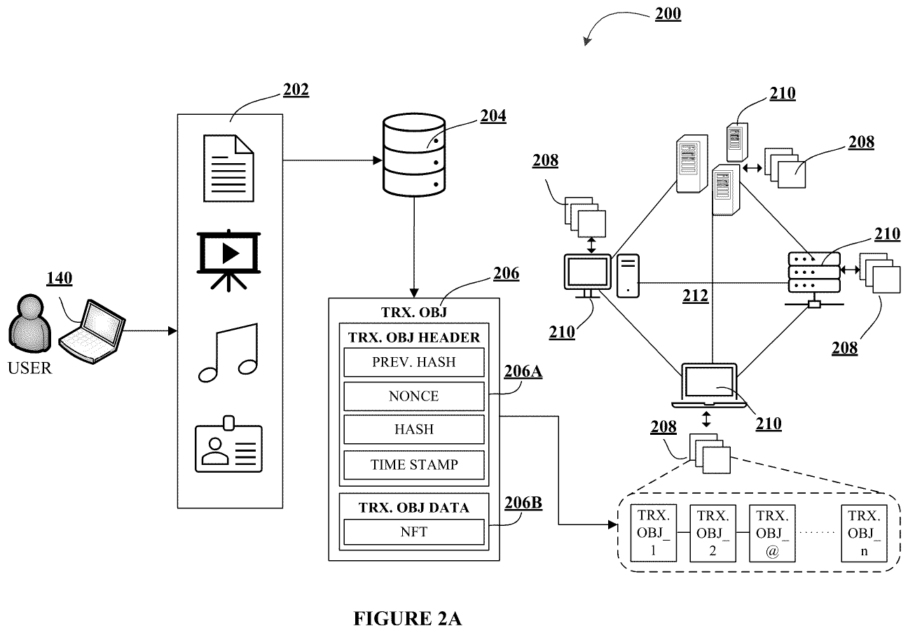

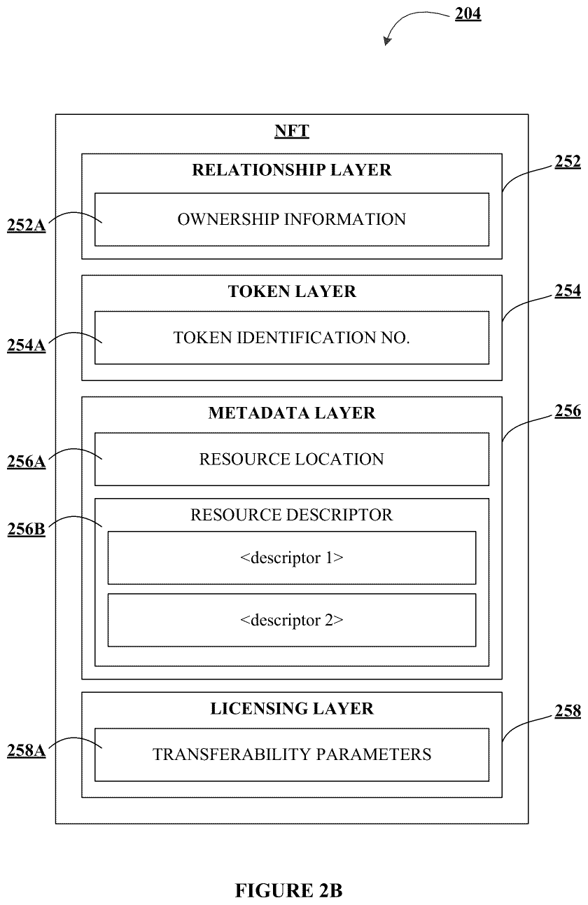

FIG. 2A illustrates an exemplary process of creating an NFT 200, in accordance with an embodiment of the invention. As shown in FIG. 2A, to create or “mint” an NFT, a user (e.g., NFT owner) may identify, using a user input device 140, resources 202 that the user wishes to mint as an NFT. Typically, NFTs are minted from digital objects that represent both tangible and intangible objects. These resources 202 may include a piece of art, music, collectible, virtual world items, videos, real-world items such as artwork and real estate, or any other presumed valuable object. These resources 202 are then digitized into a proper format to produce an NFT 204. The NFT 204 may be a multi-layered documentation that identifies the resources 202 but also evidences various transaction conditions associated therewith, as described in more detail with respect to FIG. 2A.

To record the NFT in a distributed ledger, a transaction object 206 for the NFT 204 is created. The transaction object 206 may include a transaction header 206A and a transaction object data 206B. The transaction header 206A may include a cryptographic hash of the previous transaction object, a nonce—a randomly generated 32-bit whole number when the transaction object is created, cryptographic hash of the current transaction object wedded to the nonce, and a time stamp. The transaction object data 206B may include the NFT 204 being recorded. Once the transaction object 206 is generated, the NFT 204 is considered signed and forever tied to its nonce and hash. The transaction object 206 is then deployed in the distributed ledger 208. At this time, a distributed ledger address is generated for the transaction object 206, i.e., an indication of where it is located on the distributed ledger 208 and captured for recording purposes. Once deployed, the NFT 204 is linked permanently to its hash and the distributed ledger 208, and is considered recorded in the distributed ledger 208, thus concluding the minting process.

As shown in FIG. 2A, the distributed ledger 208 may be maintained on multiple devices (nodes) 210 that are authorized to keep track of the distributed ledger 208. For example, these nodes 210 may be computing devices such as system 130 and end-point device(s) 140. One node 210 may have a complete or partial copy of the entire distributed ledger 208 or set of transactions and/or transaction objects on the distributed ledger 208. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 2B illustrates an exemplary NFT 204 as a multi-layered documentation of a resource, in accordance with an embodiment of an invention. As shown in FIG. 2B, the NFT may include at least relationship layer 252, a token layer 254, a metadata layer 256, and a licensing layer 258. The relationship layer 252 may include ownership information 252A, including a map of various users that are associated with the resource and/or the NFT 204, and their relationship to one another. For example, if the NFT 204 is purchased by buyer B1 from a seller S1, the relationship between B1 and S1 as a buyer-seller is recorded in the relationship layer 252. In another example, if the NFT 204 is owned by O1 and the resource itself is stored in a storage facility by storage provider SP1, then the relationship between O1 and SP1 as owner-file storage provider is recorded in the relationship layer 252. The token layer 254 may include a token identification number 254A that is used to identify the NFT 204. The metadata layer 256 may include at least a file location 256A and a file descriptor 256B. The file location 256A may provide information associated with the specific location of the resource 202. Depending on the conditions listed in the smart contract underlying the distributed ledger 208, the resource 202 may be stored on-chain, i.e., directly on the distributed ledger 208 along with the NFT 204, or off-chain, i.e., in an external storage location. The file location 256A identifies where the resource 202 is stored. The file descriptor 256B may include specific information associated with the source itself 202. For example, the file descriptor 256B may include information about the supply, authenticity, lineage, provenance of the resource 202. The licensing layer 258 may include any transferability parameters 258B associated with the NFT 204, such as restrictions and licensing rules associated with purchase, sale, and any other types of transfer of the resource 202 and/or the NFT 204 from one person to another. Those skilled in the art will appreciate that various additional layers and combinations of layers can be configured as needed without departing from the scope and spirit of the invention.

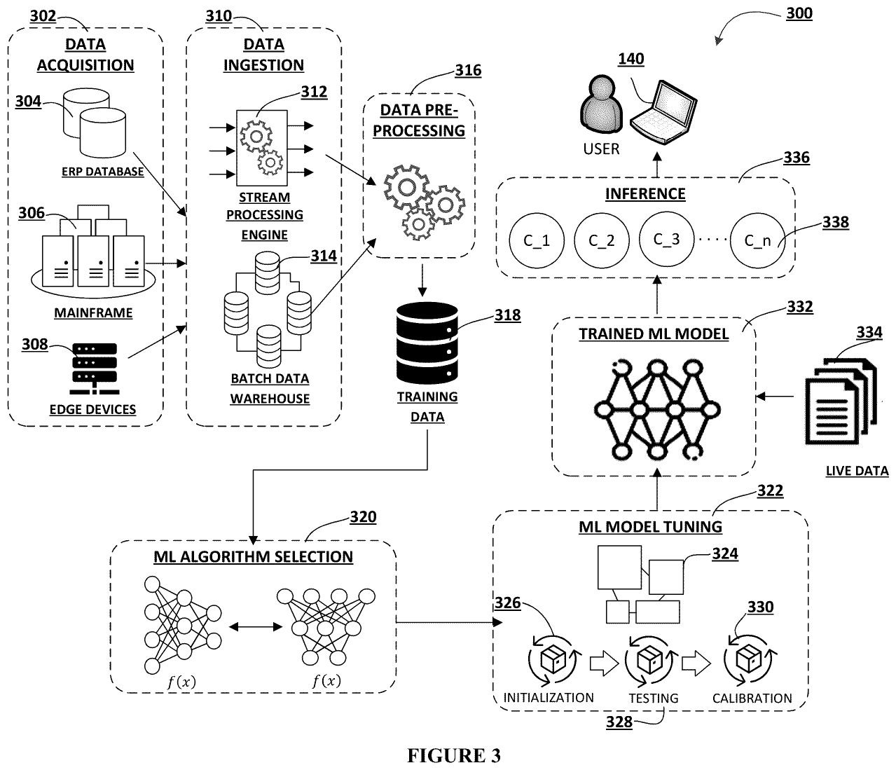

FIG. 3 illustrates an exemplary machine learning (ML) subsystem architecture 300, in accordance with an embodiment of the invention. The machine learning subsystem 300 may include a data acquisition engine 302, data ingestion engine 310, data pre-processing engine 316, ML model tuning engine 322, and inference engine 336.

The data acquisition engine 302 may identify various internal and/or external data sources to generate, test, and/or integrate new features for training the machine learning model 324. These internal and/or external data sources 304, 306, and 308 may be initial locations where the data originates or where physical information is first digitized. The data acquisition engine 302 may identify the location of the data and describe connection characteristics for access and retrieval of data. In some embodiments, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 304, 306, and 308 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In machine learning, the quality of data and the useful information that can be derived therefrom directly affects the ability of the machine learning model 324 to learn. The data pre-processing engine 316 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 318 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 322 may be used to train a machine learning model 324 using the training data 318 to make predictions or decisions without explicitly being programmed to do so. The machine learning model 324 represents what was learned by the selected machine learning algorithm 320 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 322 may repeatedly execute cycles of experimentation 326, testing 328, and tuning 330 to optimize the performance of the machine learning algorithm 320 and refine the results in preparation for deployment of those results for consumption or decision making. To this end, the ML model tuning engine 322 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained machine learning model 332 is one whose hyperparameters are tuned and model accuracy maximized.

The trained machine learning model 332, similar to any other software application output, can be persisted to storage, file, memory, or application, or looped back into the processing component to be reprocessed. More often, the trained machine learning model 332 is deployed into an existing production environment to make practical business decisions based on live data 334. To this end, the machine learning subsystem 300 uses the inference engine 336 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 338) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 338) live data 334 based on how similar they are to one another to solve exploratory challenges where little is known about the data, provide a description or label (e.g., C_1, C_2 . . . C_n 338) to live data 334, such as in classification, and/or the like. These categorized outputs, groups (clusters), or labels are then presented to the user input system 130. In still other cases, machine learning models that perform regression techniques may use live data 334 to predict or forecast continuous outcomes.

It will be understood that the embodiment of the machine learning subsystem 300 illustrated in FIG. 3 is exemplary and that other embodiments may vary. As another example, in some embodiments, the machine learning subsystem 300 may include more, fewer, or different components.

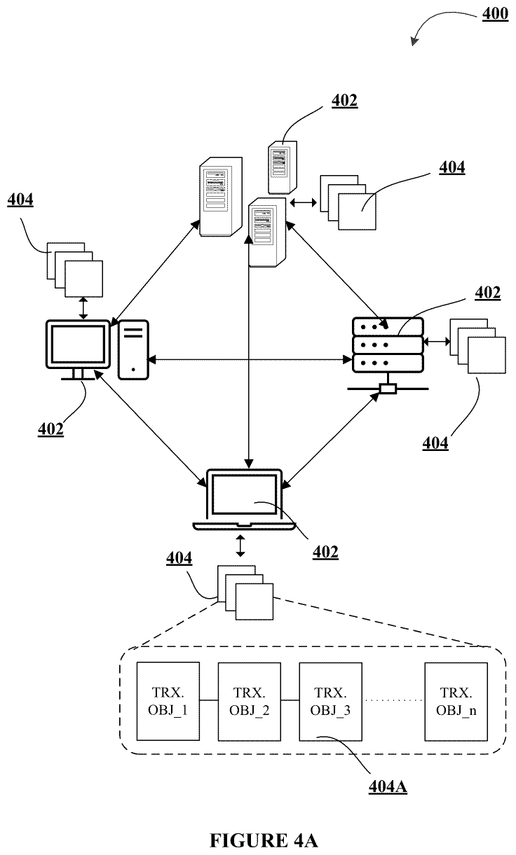

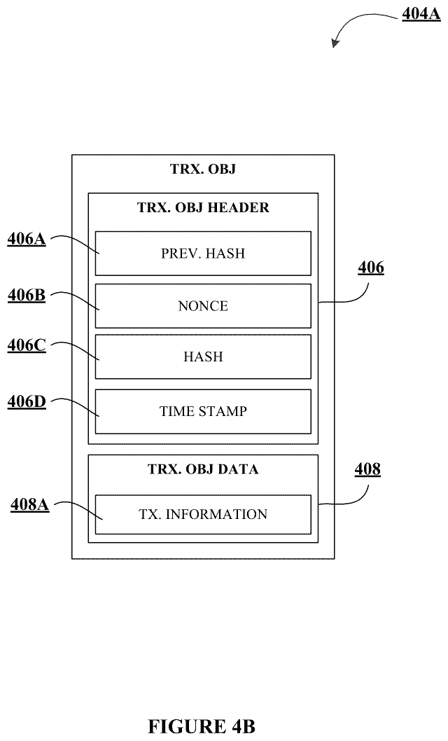

FIGS. 4A-4B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 4A, the exemplary DLT architecture 400 includes a distributed ledger 404 being maintained on multiple devices (nodes) 402 that are authorized to keep track of the distributed ledger 404. For example, these nodes 402 may be computing devices such as system 130 and client device(s) 140. One node 402 in the DLT architecture 400 may have a complete or partial copy of the entire distributed ledger 404 or set of transactions and/or transaction objects 404A on the distributed ledger 404. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 4B, an exemplary transaction object 404A may include a transaction header 406 and a transaction object data 408. The transaction header 406 may include a cryptographic hash of the previous transaction object 406A, a nonce 406B—a randomly generated 32-bit whole number when the transaction object is created, cryptographic hash of the current transaction object 406C wedded to the nonce 406B, and a time stamp 406D. The transaction object data 408 may include transaction information 408A being recorded. Once the transaction object 404A is generated, the transaction information 408A is considered signed and forever tied to its nonce 406B and hash 406C. Once generated, the transaction object 404A is then deployed on the distributed ledger 404. At this time, a distributed ledger address is generated for the transaction object 404A, i.e., an indication of where it is located on the distributed ledger 404 and captured for recording purposes. Once deployed, the transaction information 408A is considered recorded in the distributed ledger 404.

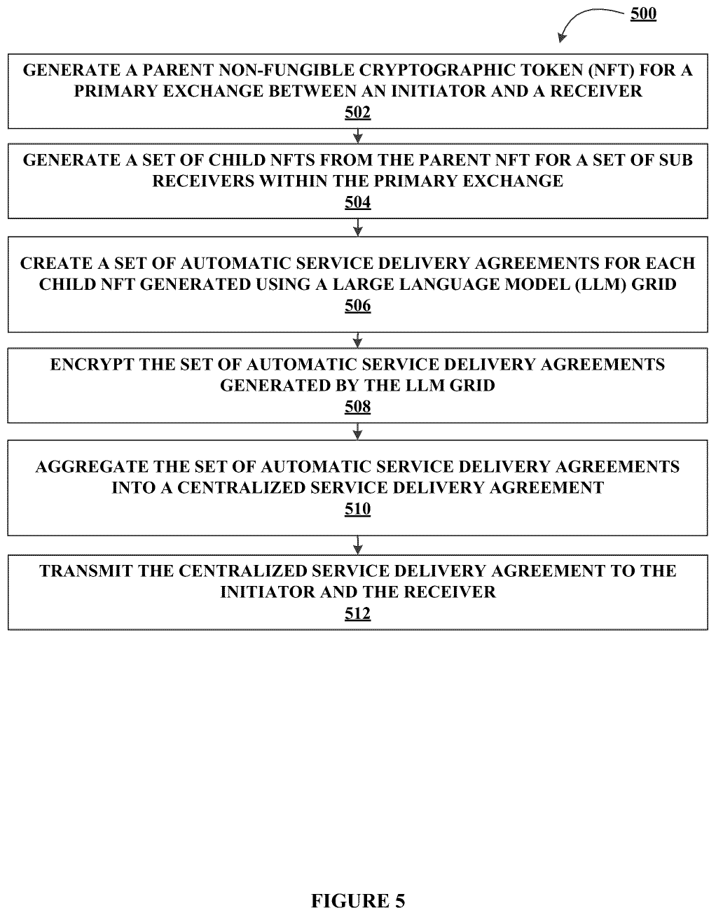

FIG. 5 illustrates a process flow for aggregating digital resources via a large language model (LLM) grid with sealed interfaces for automatic service delivery. In some embodiments, a system (e.g., similar to one or more of the systems described herein with respect to FIGS. 1A-1C) may perform one or more of the steps of process flow 500. In some embodiments, a generative artificial intelligence engine (e.g., the exemplary NFT as a multilayered documentation of a resource shown in FIG. 2A-2B and the exemplary ML subsystem architecture shown in FIG. 3) may perform some or all the steps described in process flow 500.

As illustrated in Block 502, the process flow 500 includes generating a parent non-fungible cryptographic token (NFT) for a primary exchange between an initiator and a receiver. The primary exchange may be a resource exchange comprising a plurality of sub exchanges between the initiator, the receiver, and a set of sub receivers associated with the primary exchange. The primary exchange may include a request, providing data, offering value, and/or create a set of initial parameters for the resource exchange between the initiator, the receiver, and the set of sub receivers. The initiator of the primary exchange may be an entity, group, individual, institution, and/or combination that initiates the primary exchange. The receiver of the primary exchange may be an entity, group, individual, institution, and/or combination as described. A sub receiver within the primary exchange may be an entity, group, individual, institution associated with the primary exchange through a sub exchange. An individual sub receiver within the set of sub receivers may conduct a sub exchange within the primary exchange with the initiator. The set of sub receivers and the sub exchanges subsequentially conducted may be associated with or conducted within the parameters of the primary exchange. For instance, an individual (e.g., the initiator) purchasing a house (e.g., the primary exchange) from an owner (e.g., the receiver) may have multiple sub receivers within the exchange. The individual may conduct multiple exchanges within the primary exchange between the initiator and the set of sub receivers (e.g., the individual may have a sub exchange with an appraiser of the house, inspectors, and/or surveyors). Generation of the parent NFT or a child NFT may guarantee the primary exchange and/or sub exchange will be performed (e.g., the resource exchange described has been initiated, agreed to by associated parties, and/or completed) within the parameters and guidelines specified within the primary exchange and parent NFT.

From the primary exchange between the initiator and the receiver, a parent NFT may be generated. The parent NFT based on the primary exchange may encapsulate the primary exchange and the parameters of said exchange. The parent NFT may be generated as described in FIGS. 2A-2B and 4A-4B. The primary exchange may be recorded using distributed ledger technology to record the primary exchange and interactions between partners within the primary exchange including but not limited to the initiator, the receiver, and the set of sub receivers.

As illustrated in Block 504, the process flow 500 includes generating a set of child NFTs from the parent NFT for a set of sub receivers within the primary exchange. The parent NFT (as described in FIGS. 2A-2B) may create a set of child NFTs connected to the parent NFT, as described in greater detail below. Further, a parent NFT may produce a plurality of child NFTs, with an individual child NFT for individual sub receivers within the set of sub receivers. For instance, in a primary exchange of purchasing a house, a child NFT may be generated if the initiator conducting the exchange with the receiver involves a third party (e.g., an appraiser). The third party in the form of an appraiser may have a child NFT generated from the parent NFT to document, track, denote, and monitor the sub exchange occurring between the initiator and the sub receiver, as the sub exchange is part of the primary exchange (appraisal is conducted to purchase the house). A parent NFT may generate a plurality of child NFTs, with a child NFT linked to an individual sub receiver within the set of sub receivers. In other words, the parent NFT may track the primary exchange between the initiator and the receiver, and sub exchanges may be tracked by the child NFTs generated between the initiator and the sub receivers.

In some embodiments, a child NFT may be generated for an offline sub receiver. If a sub exchange is conducted between the initiator and a sub receiver offline (e.g., a physical contract is signed), a child NFT may be generated/minted for the offline sub exchange. For instance, a physical contract signed between the initiator of the primary exchange and a third party may be a sub exchange within the primary exchange. The physical contract may be recorded within a child NFT and within the overall parent NFT when conducted as part of the primary exchange.

As illustrated in Block 506, the process flow 500 includes creating a set of automatic service delivery agreements for each child NFT generated using a large language model (LLM) grid. An automatic service delivery agreement for each child NFT may be a contract, agreement, deal, and/or resolution between the initiator and a sub receiver within a sub exchange or a receiver within the primary exchange. The automatic service delivery agreement may be conducted at least partially with the child NFT within the set of child NFTs and the parent NFT. The automatic service delivery agreement may be created using machine learning as described in FIG. 3. The machine learning described may be a LLM grid, wherein the LLM grid comprises a plurality of large language models. An individual LLM within the LLM grid may be configured, trained, and/or specialized to create automatic service delivery agreements for individual sub receivers within the set of sub receivers. For instance, for a primary exchange comprising purchasing a house, an individual LLM within the LLM grid may be configured to create a service delivery agreement between the initiator and a sub receiver in the form of an appraiser. The automatic service delivery agreement between the initiator and the sub receiver may dictate, set parameters, regulate, and/or determine the services and goods exchanged between the initiator and the sub receiver.

In some embodiments, a child NFT may be generated for an offline sub receiver and create a corresponding service delivery agreement associated with the offline sub receiver. For instance, a physical contract, agreement, or non-virtual deal between the initiator and a sub receiver may be recorded through generation of a child NFT from the parent NFT. A service delivery agreement may then be generated adhering to the terms and conditions set in the offline agreement between the initiator and the sub receiver. In some embodiments, the service delivery agreement generated by the LLM within the LLM grid may add additional regulations, restrictions, guarantees, guidelines, and/or stipulations for the sub exchange between the initiator and the sub receiver. For instance, a contractor hired by the initiator purchasing a house from the receiver may agree to perform a service in an offline setting. This agreement may be recorded through the generation of a child NFT, and the service delivery agreement generated for the provided service may list precautionary measures the contractor is required to adhere to while performing the agreed service.

In some embodiments, evaluations associated with the set of automatic service delivery agreements are received from the initiator. Evaluations received from the initiator may comprise, rankings, reviews, and/or comments regarding the sub receiver utilized in an individual sub exchange. Reception of evaluations from the initiator may “grade” individual sub receivers involved within the primary exchange and sub exchanges. This may provide data on which sub receivers may be recommended for further primary exchanges and cause individual sub receivers to be suggested over others, as described in greater detail below.

In some embodiments, sub receivers from the set of sub receivers may be recommended to the initiator via a machine learning model (MLM) based on evaluations from previously encountered initiators. Evaluations from the initiator may be analyzed and processed by the MLM to determine which sub receivers should be recommended in future primary exchanges. The MLM may use information associated with the initiator, receiver, the set of sub receivers, and the primary and sub exchanges to determine which sub receivers may be recommended. The MLM may be embodied by the machine learning architecture described in FIG. 3. The MLM may utilize reinforcement learning or supervised learning to process the received evaluations to tailor and personalize recommendations to a future initiator of another primary exchange. Information associated with the initiator and sub receivers may further be used by the MLM to determine which sub receivers may be recommended, as described in greater detail below.

In some embodiments, creation of automatic service delivery agreements by the LLM grid is at least partially altered based on a geographic location and a set of regulations associated with the geographic location. Sub receivers may be recommended based on geographic location or the set of regulations depending on information associated with the primary exchange, the sub exchange, the initiator, and evaluations associated with the set of sub receivers.

As illustrated in Block 508, the process flow 500 includes encrypting the set of automatic service delivery agreements generated by the LLM grid. The set of service delivery agreements generated by the LLM grid may be encrypted through dual encryption and/or homomorphic encryption (sealed interfaces). Forms of homomorphic encryption used may include but may not be limited to partially homomorphic encryption (PHE), somewhat homomorphic encryption (SHE), and fully homomorphic encryption (FHE). Other encryption forms including but not limited to Rivest-Shamir-Adleman (RSA) encryption and advanced encryption standard (AES) encryption. For instance, authorization and authentication of the set of automatic service delivery agreements may be encrypted using RSA encryption to ensure authorized groups can access the automatic service delivery agreements. Access of the set of service delivery agreements may be restricted by generating a public cryptographic key and a private cryptographic key, where the public cryptographic key may encrypt the set of automatic service delivery agreements and the private cryptographic key may decrypt and authenticate the set of automatic service delivery agreements. AES encryption may be utilized for subsequent data exchanges, e.g., transferring the encrypted set of automatic service delivery agreements between a first party and a second party.

As illustrated in Block 510, the process flow 500 includes aggregating the set of automatic service delivery agreements into a centralized service delivery agreement. Aggregation of the set of automatic service delivery agreements into a centralized service delivery agreement may combine, connect, and or link individual service delivery agreements within the set to make a single service delivery agreement. For instance, a centralized delivery agreement may include the primary exchange between the initiator and the receiver, as well as the set of sub exchanges between the initiator and the set of sub receivers. The centralized service delivery agreement may further include the set of automatic service delivery agreements generated by the LLM grid, specifying the parameters, rules, and regulations of a sub exchange between the initiator and sub receiver. The centralized service delivery agreement may be a combination of the set of automatic service delivery agreements into a single comprehensive automatic service delivery agreement.

As illustrated in Block 512, the process flow 500 includes transmitting the centralized service delivery agreement to the initiator and the receiver. The centralized service delivery agreement after encryption may be transmitted to the receiver and initiator. Transmission of the centralized service delivery agreement may comprise transferring the parent NFT, the set of child NFTs and the set of automatic service delivery agreements consolidated into the central service delivery agreement as previously described. In some embodiments, the centralized service delivery agreement may be transmitted to the initiator, the receiver, and the set of sub receivers.

In some embodiments, generation of a parent NFT may validate the receiver of the primary exchange and generation of a child NFT may validate the sub receiver of a sub exchange. The parent and/or child NFT may validate the parties involved within the exchange and record the exchange within a blockchain ledger with the cryptographic signature of the associated parties recorded on the blockchain ledger. The validation of the receiver and sub receivers within the primary exchange and sub exchange may affirm identities and confirm the existence of the exchange and may provide proof of the overall exchange.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random-access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for aggregating digital resources via a large language model (LLM) grid with sealed interfaces for automatic service delivery, the system comprising:
a processing device;
at least one non-transitory storage device; and
at least one processing device coupled to the at least one non-transitory storage device, wherein the at least one processing device is configured to:
generate a parent non-fungible cryptographic token (NFT) for a primary exchange between an initiator and a receiver;
generate a set of child NFTs from the parent NFT for a set of sub receivers within the primary exchange, wherein a child NFT within the set of child NFTs is linked to a sub receiver within the set of sub receivers;
validate the receiver and the set of sub receivers within the primary exchange;
create a set of automatic service delivery agreements for each child NFT generated using individual large language models (LLM) within a LLM grid, wherein individual LLMs create corresponding automatic service delivery agreements within the set of automatic service delivery agreements;
encrypt the set of automatic service delivery agreements generated by the LLM grid;
aggregate the set of automatic service delivery agreements into a centralized service delivery agreement, wherein the centralized service delivery agreement specifies parameters of the primary exchange between the initiator and the receiver, and specifies parameters between the initiator and the set of sub receivers; and
transmit the centralized service delivery agreement to the initiator and the receiver.

2. The system of claim 1, wherein the processing device is further configured to generate a child NFT for an offline sub receiver and create corresponding automatic service delivery agreements associated with the offline sub receiver and child NFT.

3. The system of claim 1, wherein the processing device is further configured to receive evaluations associated with the set of automatic service delivery agreements by the initiator.

4. The system of claim 3, wherein the processing device is further configured to recommend sub receivers from the set of sub receivers via a machine learning model (MLM) based on evaluations from previously encountered initiators.

5. The system of claim 1, wherein creation of automatic service delivery agreements by the LLM grid is at least partially altered based on a geographic location and a set of regulations associated with the geographic location.

6. The system of claim 1, wherein the set of automatic service delivery agreements are encrypted using homomorphic encryption.

7. The system of claim 1, wherein the set of automatic service delivery agreements are encrypted using dual encryption.

8. A computer program product for aggregating digital resources via a large language model (LLM) grid with sealed interfaces for automatic service delivery, the computer program product comprising at least one non-transitory computer-readable medium having computer-readable program code portions embodied therein, the computer-readable program code portions which when executed by a processing device are configured to cause a processor to perform the following operations:
generate a parent non-fungible cryptographic token (NFT) for a primary exchange between an initiator and a receiver;
generate a set of child NFTs from the parent NFT for a set of sub receivers within the primary exchange, wherein a child NFT within the set of child NFTs is linked to a sub receiver within the set of sub receivers;
validate the receiver and the set of sub receivers within the primary exchange;
create a set of automatic service delivery agreements for each child NFT generated using individual large language models (LLM) within a LLM grid, wherein individual LLMs create corresponding automatic service delivery agreements within the set of automatic service delivery agreements;
encrypt the set of automatic service delivery agreements generated by the LLM grid;
aggregate the set of automatic service delivery agreements into a centralized service delivery agreement, wherein the centralized service delivery agreement specifies parameters of the primary exchange between the initiator and the receiver, and specifies parameters between the initiator and the set of sub receivers; and
transmit the centralized service delivery agreement to the initiator and the receiver.

9. The computer program product of claim 8, wherein the processing device is further configured to cause the processor to generate an offline child NFT for a service delivery agreement created by an offline sub receiver.

10. The computer program product of claim 8, wherein the processing device is further configured to cause the processor to receive evaluations associated with the set of automatic service delivery agreements by the initiator.

11. The computer program product of claim 10, wherein the processing device is further configured to cause the processor to recommend sub receivers from the set of sub receivers via a machine learning model (MLM) based on evaluations from previously encountered initiators.

12. The computer program product of claim 8, wherein creation of automatic service delivery agreements by the LLM grid is at least partially altered based on a geographic location and a set of regulations associated with the geographic location.

13. The computer program product of claim 8, wherein the set of automatic service delivery agreements are encrypted using homomorphic encryption.

14. The computer program product of claim 8, wherein the set of automatic service delivery agreements are encrypted using dual encryption.

15. A computer-implemented method for aggregating digital resources via a large language model (LLM) grid with sealed interfaces for automatic service delivery, the computer-implemented method comprising:
generating a parent non-fungible cryptographic token (NFT) for a primary exchange between an initiator and a receiver;
generating a set of child NFTs from the parent NFT for a set of sub receivers within the primary exchange, wherein a child NFT within the set of child NFTs is linked to a sub receiver within the set of sub receivers;
validating the receiver and the set of sub receivers within the primary exchange:
creating a set of automatic service delivery agreements for each child NFT generated using individual large language models (LLM) within a LLM grid, wherein individual LLMs create corresponding automatic service delivery agreements within the set of automatic service delivery agreements;
encrypting the set of automatic service delivery agreements generated by the LLM grid;
aggregating the set of automatic service delivery agreements into a centralized service delivery agreement; and
transmitting the centralized service delivery agreement to the initiator and the receiver.

16. The computer-implemented method of claim 15, wherein the computer-implemented method further comprises generating an offline child NFT for a service delivery agreement created by an offline sub receiver.

17. The computer-implemented method of claim 15, wherein the computer-implemented method further comprises receiving evaluations associated with the set of automatic service delivery agreements by the initiator.

18. The computer-implemented method of claim 17, wherein the computer-implemented method further comprises recommending sub receivers from the set of sub receivers via a machine learning model (MLM) based on evaluations from previously encountered initiators.

19. The computer-implemented method of claim 15, wherein creating automatic service delivery agreements by the LLM grid is at least partially altered based on a geographic location and a set of regulations associated with the geographic location.

20. The computer-implemented method of claim 15, wherein the set of automatic service delivery agreements are encrypted using homomorphic encryption.
